(19) United States
(12) Patent Application Publication
(10) Pub. No.: US 2009/0235471 A1
(43) Pub. Date: Sep. 24, 2009

(54) MULTI-POSITIONABLE ELECTRONIC TOOTHBRUSH

(76) Inventors: Todd H. YAMADA, Los Angeles, CA (US); Gregg M. YAMADA, Honolulu, HI (US)

Correspondence Address: Arent Fox LLP, 555 West Fifth Street, 48th Floor, Los Angeles, CA, 90013, US

(21) Appl. No.: 12/054,312

(22) Filed: Mar. 24, 2008

(51) Int. Cl. A46B 13/00; B25G 1/00; A46B 9/04

(52) U.S. Cl. 15/22.1; 15/144.1; 15/167.1

(57) ABSTRACT

A multi-positionable electronic toothbrush includes a toothbrush body, and a brush head capable of operating at a plurality of angles with respect to said toothbrush body.

### BACKGROUND

1. Field

The present disclosure relates generally to brushes, and more particularly, to the manufacture and use of a multi-positionable electronic toothbrush configured to be a highly effective alternative to traditional electronic toothbrushes.

2. Background

Traditionally, people endeavoring to take advantage of the many benefits associated with good orally hygiene have availed themselves of electronic toothbrushes. With the advent of electronic toothbrushes, consumers have come to rely on an automatic scrubbing action of the brush bristles on the surface of teeth for the efficient removal of plaque. In a sense, all that is required from the user is the ability to move the electronic toothbrush around to various locations in their mouth, requiring very little dexterity and manipulation. Since the skill level that is needed to brush properly with an electric toothbrush is minimal, all a user typically does is focus on brushing for a recommended period.

Although a good electric toothbrush will probably clean more thoroughly and effectively than manual brushing, research indicates that electronic toothbrushes still have their shortcomings. For example, for the most effective method of plague removal, studies have concluded that the toothbrush head must be angled with respect to the toothbrush body. The angled structure, commonly known among manual toothbrushes, allows the user to reach behind otherwise difficult portions of the teeth. Certainly, if a person applies the same habits about how long they will when using an angled electric toothbrush rather than a manual one, the person will be able to attain the most effective and successful method of plague removal.

### SUMMARY

One aspect of a multi-positionable electronic toothbrush is disclosed. A multi-positionable electronic toothbrush includes a toothbrush body, and a brush head capable of operating at a plurality of angles with respect to said toothbrush body.

Another aspect of a multi-positionable electronic toothbrush is disclosed. A multi-positionable electronic toothbrush includes a flexible joint, a toothbrush body, a brush head operatively connected to said toothbrush body by said flexible joint, a button mounted to said toothbrush body, and a spring operatively connected between said flexible joint and said button.

A method for operating a multi-positionable electronic toothbrush is also disclosed. The method includes applying manual force to a brush head in relation to a toothbrush body, locking said brush head into a different operational angle from an initial position, and activating a button coupled to a spring mechanism thereby returning said brush head to said initial position.

These, as well as other objects, features and benefits will now become clear from a review of the following detailed description of illustrative embodiments and the accompanying drawings.

### DESCRIPTION OF DRAWINGS

Aspects of the present invention are illustrated by way of example, and not by way of limitation, in the accompanying drawings wherein:

FIG. 1 illustrates a partial view of a multi-positionable electronic toothbrush;

FIG. 2A-2B illustrates a cross section view along line B-B of FIG. 1;

FIG. 3A illustrates a detailed view of a retractor button;

FIG. 3B illustrates a cross section view along line C-C of FIG. 1;

FIG. 4 illustrates top and side perspective views of a retractor spring; and

FIG. 5 illustrates a cross section view along line A-A of FIG. 1.

### DETAILED DESCRIPTION

The detailed description set forth below in connection with the appended drawings are intended as a description of various embodiments of the invention and is not intended to represent the only embodiments in which the invention may be practiced. The detailed description includes specific details for providing a thorough understanding of the invention. However, it will be apparent to those skilled in the art that the invention may be practiced without these specific details.

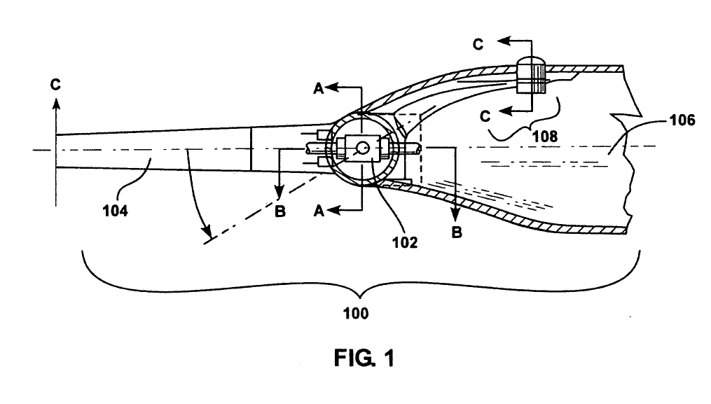

FIG. 1 illustrates a partial view of a multi-positionable electronic toothbrush. The multi-positionable electronic toothbrush 100 is comprised of a brush head 104 connected to a toothbrush body 106 via flexible drive mechanism 102 (hereinafter “flexible drive”). At its initial position, the multi-positionable electronic toothbrush 100 is capable of operating at zero degrees with respect to brush head 104 and toothbrush body 106, wherein the brush head 104 and the toothbrush body 106 share a common axis. The brush head 104 may be replaceable by the user after prolonged use and the flexible drive 102 may either be incorporated into the replaceable brush head 104 portion or permanently affixed to the toothbrush body 106. The flexible drive 102 may allow for the adjustability of the brush head 104 to any angle but typical operation may lie between 25-35 degrees. This adjustment in the operational axis may be implemented by utilizing a spring mechanism 108 that is placed laterally to the toothbrush body that encompasses the driving shaft.

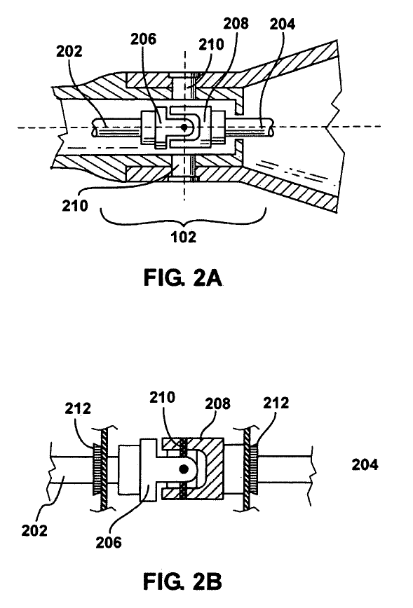

FIG. 2A-2B illustrates a cross section view along line B-B of FIG. 1. The flexible drive 102, sometimes referred to as a flexible joint, resides within the toothbrush housing and serves to join the toothbrush body 106 and the brush head 104. The flexible joint 102 allows for operation of the multi-positionable electronic toothbrush when the drive is bent at a second operational angle or second operational axis. Though the multi-positionable electronic toothbrush is herein described as operating at two angles, one of ordinary skill in the art may appreciate that this disclosure may readily be applied to a multi-positionable electronic toothbrush that operates at any plurality of operating axes.

The flexible drive 102 itself is comprised of a driving shaft 204 and a driven shaft 202 that are connected by a set of couplers 206, 208, wherein, the coupled structure is held together by a plastic pins 210. The transmission of rotational motion from the driving shaft 204 is a universal requirement. That is, the toothbrush body 106 may have an electric motor (not shown) that supplies the rotational energy necessary to control the rotational or vibration cleaning power of the cleaning bristles. The cleaning power is supplied via a driven shaft 202 extending axially about the brush head 104.

The couplers 206, 208 are located 90° relative to each other and are affixed to one another by a four-sided cross structure. This design allows the multi-positionable electronic toothbrush to efficiently operate at its initial position and at at least one other operational angle without any degradation in cleaning power. In fact, it is precisely due to the additional angle that a user may be better able to remove plague buildup. The flexible drive 102 is also comprised of a set of bushings 212 as shown in FIG. 2B. Both the driving shaft 204 and the driven shaft 202 are held in place by the bushings 212 so as to minimize the amount of movement the shafts 202, 204 experience.

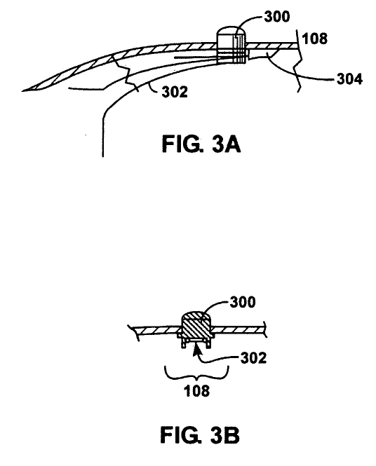

The retractor button is shown in FIGS. 3A and 3B. The spring mechanism 108 is comprised of a retractor button 300 and a spring 302. The spring 302 is a U-shaped spring that straddles the driving shaft 204. The U-shaped ends of the spring 302 may be screwed onto the flexible drive mechanism 102. The opposite end of the affixed U-shaped ends is stowed away under the button 300. The button 300 may contain a channel on the underside of the button 300 so as to allow for the sliding motion of the spring 302 substantially along the underside channel.

The button 300 is prevented from being ejected by a flange (not shown) that extends substantially about the circumference of the button 300. As the brush head 104 is depressed downward to engage the second operational axis, the spring 302 is bent and slides toward the brush head 104. The spring 302 slides within the confines of the button 300 via an underside channel. The sliding process of the spring 302 allows the spring 302 to clear the plastic ledge 304 and thus push the button 300 upward. The button 300 is thereby engaged in its up position since the spring 302 is unable to slide backwards as a result of the plastic ledge 304. Since the spring 302 is now under a load, by pushing downward on the button 300 the spring 302 is disengaged and released. This process allows the spring 302 to slide backwards within the underside channel of the button 300. As the spring 302 slides back to its initial position, the brush head 104 rotates back to its original straight position, i.e., zero degrees with respect to the toothbrush body 106.

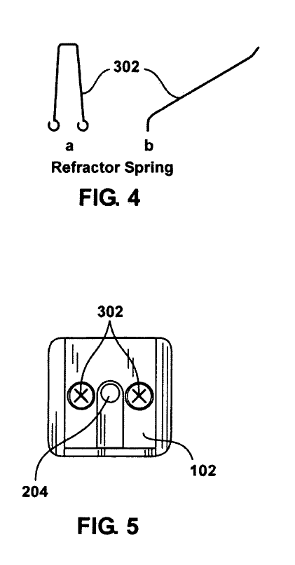

The retractor spring is shown in FIG. 4. FIG. 4 illustrates a top perspective view of the substantially U-shaped spring 302a and also illustrates a side perspective view of the spring 302b. As described above in detail, the spring 302 is a substantially U-shaped spring that may straddle the driving shaft 204 so as to remain clear of the rotational operation of the driving shaft 204. The spring 302 may be a cantilever-type spring affixed to the flexible joint 102. Although a cantilever-type spring is disclosed herein, any other type of spring capable of providing the substantially same function may be substituted without straying from the teachings disclosed. Additionally, the individual ends of the spring 302 may be screwed onto, or otherwise affixed to, the flexible drive mechanism 102.

Upon placing the flexible drive 102 into an angled position, a user may continue to operate the multi-positionable electronic toothbrush 100 at a second operational angle or axis. At the instant the user likewise depresses the button 300, the spring 302 will decompress and return the multi-positionable electronic toothbrush 100 to its original position.

FIG. 5 illustrates a cross section view along line A-A of FIG. 1. The spring 302 may be attached by screws onto the flexible drive mechanism 102 (as shown). The clearance necessary for the continuous operation of the driving shaft 204 is accomplished by the substantially u-shaped spring 302 that bestrides the driving shaft 204. As one of ordinary skill in the art may appreciate, one may use other attaching alternatives such as rivets, pins, bolts, or other fastening means to affix the spring 302 to the flexible drive mechanism 102.

While the specification describes particular embodiments of the present invention, those of ordinary skill can devise variations of the present invention without departing from the inventive concept. Also, the previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language of the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A multi-positionable electronic toothbrush, comprising:
a toothbrush body;
a brush head capable of operating at a plurality of angles with respect to said toothbrush body, the plurality of angles including a straight position and an angled position; and
a spring coupled to the brush head such that as the brush head is positioned from the straight position to the angled position, the spring is increasingly put under a load through movement of the brush head.

2. The multi-positionable electronic toothbrush of claim 1 further comprising a flexible drive having a driving shaft and a driven shaft, wherein said flexible drive is configured to facilitate operation at said plurality of angles.

3. The multi-positionable electronic toothbrush of claim 2 further comprising a button on said toothbrush body configured to release the load from the spring and to reset the flexible drive so that said driving and driven shafts return to a common axial orientation.

4. The multi-positionable electronic toothbrush of claim 3, wherein said spring is configured to reset said flexible drive into said axial orientation once said button is depressed.

5. The multi-positionable electronic toothbrush of claim 4 wherein said spring comprises a cantilever-type spring laterally affixed to said flexible drive.

6. The multi-positionable electronic toothbrush of claim 4 wherein said spring is configured to compress upon placing said flexible drive into an angled position and decompress upon depressing said button.

7. The multi-positionable electronic toothbrush of claim 1 wherein at least one of said plurality of angles is within 25-35 degrees with respect to said toothbrush body.

8. The multi-positionable electronic toothbrush of claim 1 wherein said brush head is replaceable.

9. A multi-positionable electronic toothbrush, comprising:
a flexible joint;
a toothbrush body;
a brush head operatively connected to said toothbrush body by said flexible joint so as to operate in a straight position and in an angled position;
a button mounted to said toothbrush body; and
a spring operatively connected between said flexible joint and said button such that as the brush head is positioned from the straight position to the angled position, the spring is increasingly put under a load through movement of the brush head.

10. The multi-positionable electronic toothbrush of claim 9 wherein said flexible joint comprises a flexible drive having a driving shaft and a driven shaft.

11. The multi-positionable electronic toothbrush of claim 10 wherein said button is configured to reset said flexible joint so that said driving and driven shafts return to a common axial orientation.

12. The multi-positionable electronic toothbrush of claim 10 wherein said spring is configured to reset said flexible joint so that said driving and driven shafts return to a common axial orientation once said button is depressed.

13. The multi-positionable electronic toothbrush of claim 9 wherein said spring comprises a cantilever-type spring laterally affixed to said flexible joint.

14. The multi-positionable electronic toothbrush of claim 9 wherein said spring is configured to compress upon placing said flexible joint into the angled position and decompress upon depressing said button.

15. The multi-positionable electronic toothbrush of claim 9 wherein at least one operational angle is within 25-35 degrees with respect to said toothbrush body.

16. The multi-positionable electronic toothbrush of claim 9 wherein said brush head is replaceable.

17. The multi-positionable electronic toothbrush of claim 9 wherein said spring comprises a cantilever-type spring laterally affixed to said flexible joint and is configured to compress upon placing said flexible joint into the angled position and decompress upon depressing said button, further wherein said angled position is within 25-35 degrees with respect to said toothbrush body, and said brush head is replaceable.

18. A method of operating a multi-positionable electronic toothbrush, comprising: applying manual force to a brush head in relation to a toothbrush body;
increasing a load on a spring coupled to the brush head as manual force is applied to the brush head in relation to the toothbrush body;
locking said brush head into a different operational angle from an initial position; and
activating a button coupled to a spring mechanism thereby returning said brush head to said initial position through release of the load.

19. The method of operating a multi-positionable electronic toothbrush of claim 18 wherein said different operational angle is between 25-35 degrees with respect to said toothbrush body.

20. The method of operating a multi-positionable electronic toothbrush of claim 18 wherein said initial position requires an operational angle between 0-25 degrees with respect to said toothbrush body.
